(19) United States
(12) Patent Application Publication
(10) Pub. No.: US 2011/0050134 A1
(43) Pub. Date: Mar. 3, 2011

(54) Series electric engine power drive

(76) Inventor: John Kissane, Far Hills, NJ (US)

(21) Appl. No.: 12/584,191

(22) Filed: Sep. 2, 2009

(51) Int. Cl. H02P 31/00

(52) U.S. Cl. 318/139

(57) ABSTRACT

The motor generator set is described where in the output from the motor driven generator is fed back to the input of the electric motor in series with the power from the battery, which energizes the motor. Diodes are provided in this unique circuitry between the output of the generator and the input of the motor between the output of the motor and input of the generator, and between the battery and the input of the electric motor to direct current into the electric motor.

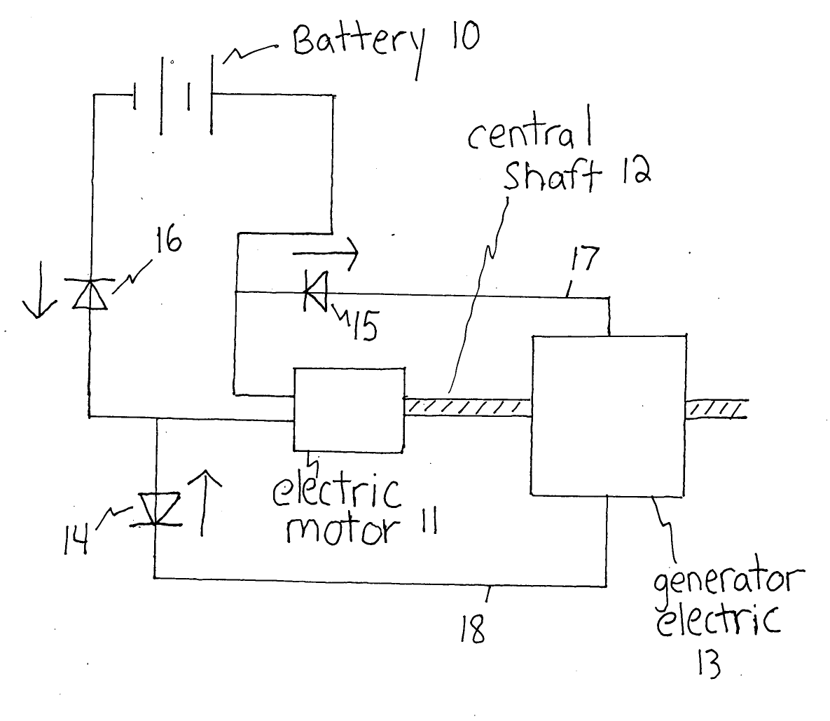

### CROSS-REFERENCED TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to a unique motor generator set. In particular to a motor generator set where in the output of the generator is fed back in series to the electric motor.

In the past motor generator sets have been used in automobiles where the electric generated by the generator is sent back to the battery. This only resulted in charging the battery.

### BRIEF SUMMARY OF THE INVENTION

The present invention compromises a motor driven generator where in the output from the generator is fed back directly to the electric motor. In this configuration the voltage from the generator is additive with the voltage from the battery. Therefore there is more electric power directed into the motor that drives the system. Means are also provided (by the use of diodes) to prevent the output power from the generator to flow back to the battery. The output from the generator is in series with the output of the battery.

### BRIEF DESCRIPTION OF THE DRAWING

The drawing shows a schematic illustration of the motor generator invention, wherein the output of the generator is fed back in series with the output of the battery to the input of the motor.

### DETAILED DESCRIPTION OF THE INVENTION

Referring more particularly to the drawing a battery 10 is connected to the input of an electric motor 11 to energize the motor. Electric motor 11 has a central shaft 12 which drives a generator 13 mounted on central shaft 12. The output voltage from the generator is fed back to the input of the electric motor 11 through diodes 14 and 15. Diode 16 is connected between the battery 10 and the motor 11 whereby it prevents the backflow of electricity from the generator 13 to the electric motor 11. Because the diode 16 allows electricity to flow in only one direction electricity from the generator 13 cannot flow back to the battery 10. Instead it pairs up with the electricity from the battery 10 and flows to the motor.

In operation, electric motor 11 is energized by the battery 10 and rotates generator 13 to produce electric power on output leads 17 and 18. This power is fed back through diodes 15 and 16 to the input of the electric motor 11. This is similar to a series hook up with the battery and functions in an additive manner. The benefit of this unique circuitry results in enhanced power to the motor and results in an increased torque from the motor.

What I claim as my invention is:

1. Unique circuitry for a motor generator set compromising, an electric motor, a central shaft driven by said electric motor, a generator fixedly mounted on said central shaft, a battery connected to the input of said electric motor, means for feeding back the output from said generator to the input of said electric motor, and diodes in the circuitry between generator and motor directing the current into the motor, and a diode between the output of the battery and the input of the electric motor such that it prevents power from the generator from flowing to the battery.
